(19) United States
(12) Patent Application Publication
(10) Pub. No.: US 2022/0105803 A1
(43) Pub. Date: Apr. 7, 2022

(54) WORK VEHICLE

(71) Applicant: DEERE & COMPANY, Moline, IL (US)

(72) Inventors: GIOVANNI A. WUISAN, EPWORTH, IA (US); Christopher B. Howard, DUBUQUE, IA (US)

(21) Appl. No.: 17/062,287

(22) Filed: Oct. 2, 2020

(51) Int. Cl. B60K 35/00; E02F 9/16; E02F 9/26; G06F 3/14

(52) U.S. Cl. CPC B60K 35/00; E02F 9/16; E02F 9/264; G06F 3/14; B60K 2370/152; E02F 3/7609; B60K 2370/23; B60K 2370/334; B60K 2370/785; B60K 2370/52; B60K 2370/33; B60K 2370/171

(57) ABSTRACT

A work vehicle includes a chassis having a first side and a second side opposite the first side, a prime mover supported by the chassis. The operator cab is supported by the chassis and includes at least one window. An operator interface is positioned in an operator cab and configured to display information about operation of the work vehicle. A projector is configured to project the information from the operator interface onto at least one window.

### FIELD

The present disclosure relates to a work vehicle including a display on a window of an operator cab for assisting the operator in operating the work vehicle.

### SUMMARY

In one embodiment a work vehicle includes a chassis having a first side and a second side opposite the first side, a prime mover supported by the chassis, and an operator cab supported by the chassis. The operator cab includes a plurality of windows and an operator interface. A first of the plurality of windows is positioned on the first side of the chassis and a second of plurality of windows is positioned on the second side of the chassis. A work attachment is movably coupled to the chassis and is visible from one of the first window or the second window. A control system is configured to determine a characteristic of the work attachment relative to a support surface and display the characteristic of the work attachment via the operator interface. A projector is in communication with the operator interface and positioned adjacent to the one of the first window or the second window. The projector is configured to project the information from the operator interface onto the one of the first window or second window.

In another embodiment a work vehicle includes a chassis having a longitudinal axis, a prime mover supported by the chassis, and an operator cab supported by the chassis. The operator cab includes a window having an external surface that defines a vector normal thereto. The vector is parallel to a support surface and positioned at an acute angle relative to the longitudinal axis. The operator cab further includes an operator interface that has a display screen configured to display information about the operation of the work vehicle to the operator. The operator cab further includes a projector in communication with the operator interface and configured to project the information displayed by the operator interface onto the window.

In another embodiment a work vehicle includes a chassis having a first side and a second side opposite the first side, and a prime mover supported by the chassis. The operator cab is supported by the chassis and includes at least one window. An operator interface is positioned in an operator cab and configured to display information about operation of the work vehicle. A projector is configured to project the information from the operator interface onto the at least one window.

### BRIEF DESCRIPTION OF THE DRAWINGS

FIG. 1 shows a perspective view of a work vehicle including an operator cab having a plurality of windows.

FIG. 2 shows an operator's view from the cab of FIG. 1, at least one of the windows including a display in communication with an operator interface positioned in a console.

FIG. 3 shows a top view with a portion of the operator cab removed.

FIG. 4 shows a schematic of a display in communication with the operator interface.

FIG. 5 shows a first region of the display being reflected on one of the plurality of windows of the operator cab of FIG. 1.

FIG. 6 shows a second region of the display being reflected on one of the plurality of windows of the operator cab of FIG. 1.

FIG. 7 shows a third region of the display being reflected on one of the plurality of windows of the operator cab of FIG. 1.

FIG. 8 shows a fourth region of the display being reflected on one of the plurality of windows of the operator cab of FIG. 1.

FIG. 9 shows a fifth region of the display being reflected on one of the plurality of windows of the operator cab of FIG. 1.

FIG. 10 shows the display being reflected one of the plurality of windows of the operator cab of FIG. 1.

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways. Also, it is to be understood that the phraseology and terminology used herein is for the purpose of description and should not be regarded as limiting.

### DETAILED DESCRIPTION

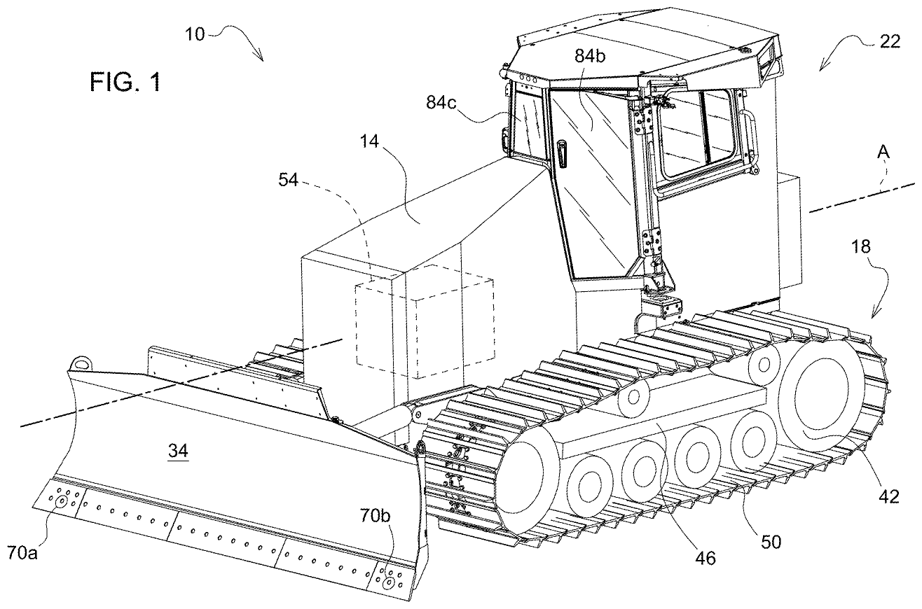

FIG. 1 illustrates a work vehicle 10, such as a dozer, having a chassis 14 and a ground-engaging member (e.g., tracks or crawler mechanisms 18) for supporting and propelling the chassis 14 and therefore the machine 10 along a support surface (e.g., ground). A longitudinal axis A of the work vehicle defines a longitudinal plane P that bisects the work vehicle 10. A first side of the work vehicle 10 exists on a first side of the longitudinal plane P and a second side of the work vehicle 10 exists on a second side of the longitudinal plane P. The crawler mechanisms 18 are on opposite sides of the longitudinal plane P and are oriented parallel to the longitudinal axis A of the chassis 14, which coincides with a forward direction of travel of the vehicle 10 during operation. In the illustrated embodiment, each crawler mechanism 18 includes a drive sprocket 42, an undercarriage frame 46, and a track 50. The drive sprocket 42 is driven by a prime mover 54 (e.g., engine) and engages the track 50. The track 50 is driven in an endless loop around the drive sprocket 42 and the undercarriage frame 46. The illustrated vehicle 10 further includes an operator cab 22, a work attachment 34 movably coupled to a front of the chassis 14, a control system 56, and an operator interface 58. In the illustrated embodiment, the work attachment is a blade 34.

Although the work vehicle 10 is illustrated and described as an dozer, it is understood that the work vehicle 10 may have a different form, such as a loader, an excavator, a motor grader, a scraper, or another type of construction, mining, agricultural, or utility vehicle. Also, although the work attachment is illustrated and described as a blade 34, it is understood that the work attachment may have a different form, such as an auger, a breaker, a ripper, a grapple, or some other type of attachment for digging, breaking, handling, carrying, dumping or otherwise engaging dirt or other material.

The work vehicle 10 may include a plurality of sensors 70a, 70a, 70b that are configured to detect information related to the work vehicle 10 and the blade 34. For example, the sensors 70a, 70b may be positioned on the blade 34. In the illustrate embodiment, the sensors 70a, 70b are position sensors but in other embodiments the sensors 70, 70b may be any suitable type of sensor. In the illustrated embodiment, a first sensor 70a may be positioned on the first side of the blade 34 and a second sensor 70b may be positioned on the second side of the blade 34. The blade 34 may also include sensors in other locations. Sensors may also be located elsewhere on the work vehicle. For example, sensors may be positioned on the chassis 14, the undercarriage frame 46, or the track 50, among other locations.

A vehicle operation system is positioned in the cab 22 and can include different combinations of input/output devices, one of which is the operator interface 58, as will be discussed herein. In some embodiments, the vehicle operation system includes other or additional input devices, such as a steering wheel, control levers, control pedals, and other suitable input devices.

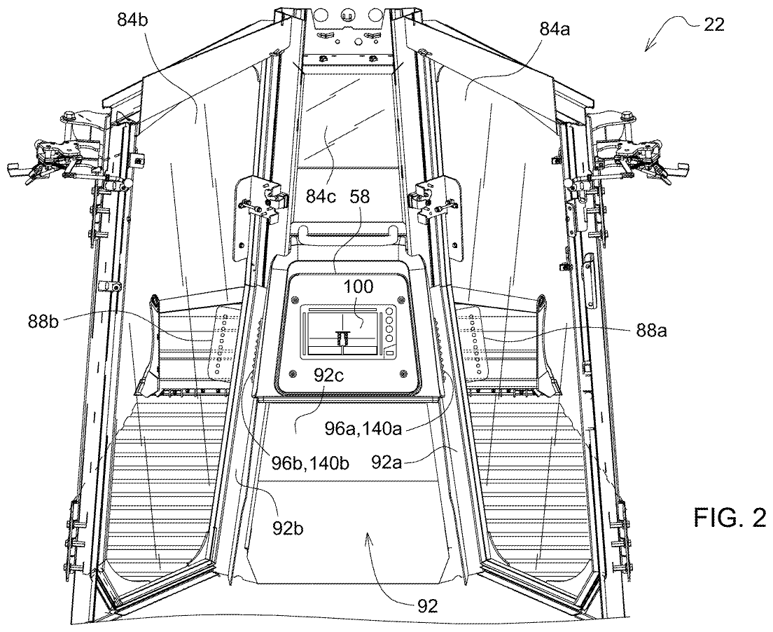

As shown in FIGS. 1-3, in the illustrated embodiment, the operator cab 22 includes at least one door 80 and a plurality of windows 84. The plurality of windows 84a, 84b, 84c includes a first window 84a (FIG. 2) positioned on the first side of the chassis 14, a second window 84b positioned on the second side of the chassis 14, and a third window 84c positioned between the first window 84a and the second window 84b. In the illustrated embodiment, one of the first or second windows 84a, 84b is included in the at least one door 80, but in other embodiments, the at least one door 80 may be separate from the plurality of windows 84a, 84b, 84c.

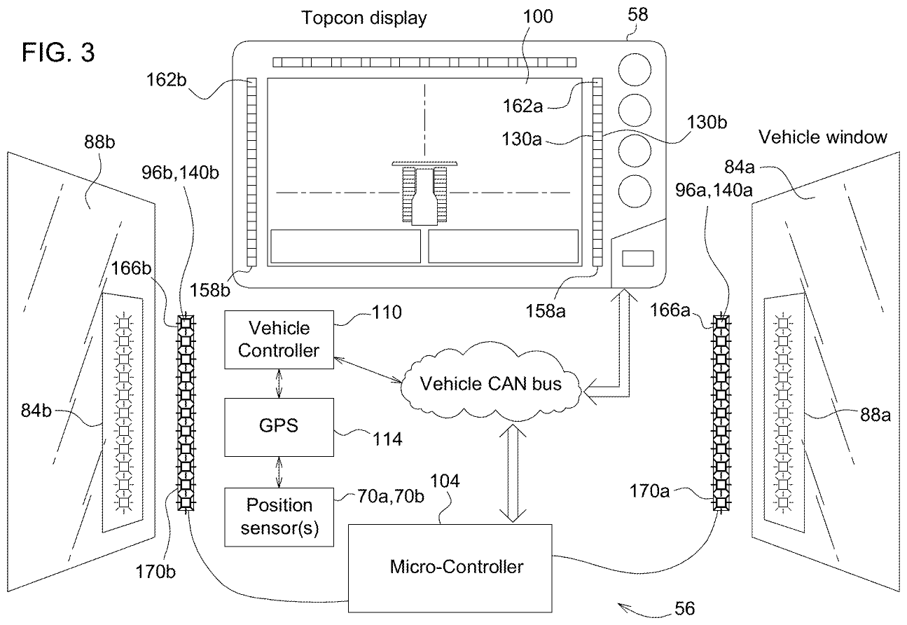

With respect to FIG. 3, each of the first window 84a and the second window 84b includes an exterior surface that is coincident with a plane Pa, Pb (or, in other embodiments, each includes an exterior surface with a point to which a plane Pa, Pb is tangent). A vector Na, Nb is normal to the respective plane Pa, Pb (or to the respective point on the exterior surface) and parallel to the support surface. The plane Pa, Pb of each of the first and second windows 84a, 84b is oriented at an acute angle α relative to the longitudinal plane P. The vector normal Na, Nb of each of the first and second windows 84a, 84b is therefore positioned at an acute angle β relative to the longitudinal axis A. In the illustrated embodiment, both the angles α, β are about 45 degrees. In other embodiments, one or both of the angles α, β may be about 30 degrees to about 90 degrees. In still other embodiments, one or both of the angles α, β may be about 30 degrees to about 60 degrees. The term “about” as used herein means plus or minus five degrees. In other embodiments, either or both of the angles may be other acute angles. With respect to FIG. 3, the third window 84c includes an exterior surface that is coincident with a plane Pc (or, in other embodiments, each includes an exterior surface with a point to which a plane Pc is tangent). A vector Nc is normal to the plane Pc (or to the respective point on the exterior surface) and parallel to the support surface. The plane Pc of each of the third window 84c is oriented at a perpendicular angle μ relative to the longitudinal plane P. The vector normal Nc of the third window 84c is therefore positioned parallel relative to the longitudinal axis A. In other embodiments, the angle μ may be any other suitable angle (e.g., less than or greater than 90 degrees).

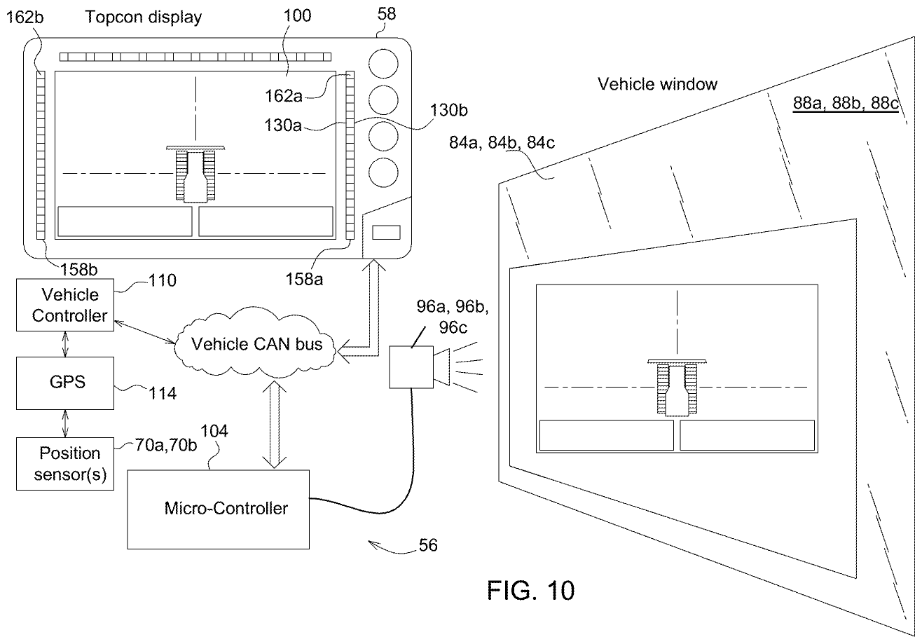

A reflective film is positioned on and adhered to at least a portion of each of the plurality of windows 84a, 84b, 84c. In the illustrated embodiments, the reflective film is designated by reference numerals 88a, 88b, 88c and is shown on only a portion of the windows 84a, 84b, 84c. In particular, the reflective film 88a, 88b, 88c may be adhered to an interior surface of the respective window 84a, 84b, 88c. In other embodiments (such as shown in FIG. 10), the reflective film 88a, 88b, 88c may extend across the entire interior surface of the respective window such that the entire window 84a, 84b, 84c may include the reflective film that is laminated or otherwise coupled thereto. In some embodiments, the reflective film may be a windshield combiner film manufactured by 3M, for example.

Further with respect to FIGS. 1-3 and FIG. 10, the operator cab further includes a console 92 and a chair 94 that is spaced apart from the console 92 and configured to support the operator. The console includes a first side 92a positioned on the first side of the chassis 14 adjacent to the first window 84a, a second side 92b positioned on the second side of the chassis 14 adjacent to the second window 84b, and a third side 92c positioned between the first side 92a and the second side 92b. With respect to FIG. 3, each of the first side 92a and the second side 92b of the console 92 includes a surface that is coincident with a plane Pc, Pd (or, in other embodiments, each includes a surface with a point to which a plane Pc, Pd is tangent). The plane Pc, Pd of each of the first and second sides 92a, 92b of the console 92 is oriented at an acute angle relative to the plane Pa, Pb of the respective first and second windows 84a, 84b. In other embodiments, the planes Pc, Pd of the first and second sides 92a, 92b of the console 92 may be substantially parallel to the respective planes Pa, Pb of the windows 84a, 84b, rather than positioned at an acute angle as shown in FIG. 3. In the illustrated embodiment, the first side 92a of the console 92 supports a first projector 96a and the second side 92a of the console 92 supports a second projector 96b. The third side 92c supports the operator interface 58, which has a display screen 100 that is configured to display information related to operation of the work vehicle 10 and the blade 34. The first and second projectors 96a, 96b are in communication with the operator interface 58 via a micro-controller 104 (e.g., an Arduino micro-controller) and are configured to display the information displayed on the operator interface 58 onto the respective first or second window 84, 84b, as discussed herein. The first and second projectors 96a, 96b are positioned such that they are aligned with or adjacent to the reflective film 88a, 88b on the respective window 84a, 84b. In another embodiment, shown in FIG. 10, either or both of the projectors 96a, 96b or a projector 96c supported elsewhere (e.g., by another side of the console 92) is configured to display the information displayed on the operator interface 58 onto the third window 84c.

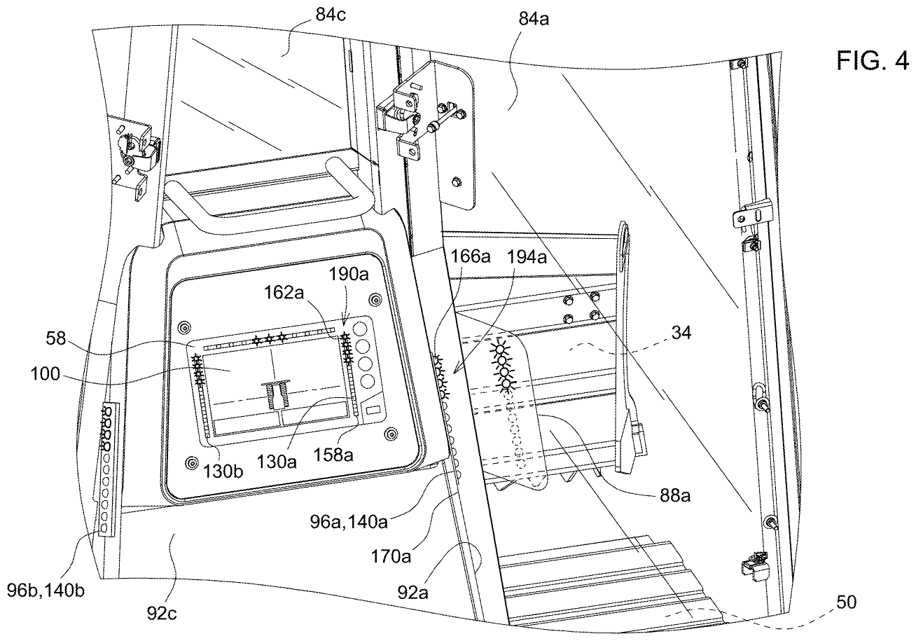

With respect to FIG. 4, the control system 24 includes a vehicle controller 110 with a plurality of inputs and outputs that are operable to receive and transmit information and commands to and from different components, such as the operator interface 58 and a global positioning system (GPS) 114. The GPS 114 is in communication with the plurality of sensors 70a, 70b. Communication between the vehicle controller 110 and the different components can be accomplished through a CAN bus (e.g., an ISO bus), another communication link (e.g., wireless transceivers), or through a direct connection. The vehicle controller 110 may also include memory for storing software, logic, and algorithms. The vehicle controller 110 also includes a processor for carrying out or executing the software, logic, algorithms, programs, set of instructions, etc. stored in the memory.

During operation, as the blade 34 moves relative to the support surface to accommodate different load levels and material types, the GPS 114 is configured to communicate the information from the plurality of sensors 70a, 70b to the vehicle controller 110. The vehicle controller 110 is configured to display the information from the GPS 114 on the display screen 100 of the operator interface 58 to assist the operator in operating the work vehicle 10. As shown in FIG. 2, the display screen 100 of the operator interface is positioned centrally within the operator cab 22. Typically, however, during operation, the operator's focus is on the first and second sides of blade 34 or the surrounding environment through one of the plurality of windows 84a, 84b, 84c. Specifically, for example, the operator typically watches the heel and toe of the blade 34 through one of the respective first and second windows 84a, 84b. Glancing from operator interface 58, which is close inside the cab 22, to the edge of the blade 34 or another location that is spaced apart from the vehicle 10, which is a much further distance, requires eyes to refocus. Continuous back and forth slows down the operator and introduces fatigue. Accordingly, the first and second projectors 96a, 96b are configured to display at least a portion of the contents from the display screen 100 onto either or both of the first and second windows 84a, 84b. Therefore, the contents from the display screen 100 and the blade 34 may be concurrently visible to the operator, and the operator can avoid taking his eyes off the blade 34 (or distant location) and shifting his gaze between the blade 34 (or distant location) and the operator interface 58.

With respect to FIGS. 2 and 4, in an exemplary embodiment, the vehicle controller 110 is configured to determine and the operator interface 58 is configured to display, via the display screen 100, a plurality of indicators corresponding to one or more characteristics of the operation of the vehicle 10. For example, the plurality of indicators may correspond to one or more of the following characteristics of the operation of the vehicle 10: a position of the blade 34 (e.g., a grade elevation of the blade 34, a distance of the blade 34 relative to the support surface, or a distance of the blade 34 relative to the chassis 14), an angle of the blade 34, a direction of the blade 34, a velocity of the blade 34, a speed of the vehicle 10, a speed of the track 50, and angle or slope of the grade of the support surface. Moreover, the plurality of indicators may also correspond to information unrelated to operation of the vehicle 10, as well, such as (but not limited to) the operator receiving a phone call or text message. These characteristics that may be identified on the operator interface 58 via one or more indicators listed above are merely exemplary. Additionally, either or both of the first and second projectors 96a, 96b are configured to display the information from the plurality of indicators on the display screen 100 on respective first or second window 84a, 84b.

With specific reference to FIG. 4, the display screen 100 in the illustrated embodiment includes, among the plurality of indicators, a first indicator and a second indicator. The first indicator is a first light source 130a on the first side of the operator interface 58 and the second indicator is a second light source 130b on the second side of the operator interface 58. In the illustrated embodiment, the first light source 130a may include LEDs that are configured to illuminate based on the sensed position of the first side of the blade 34 and the second light source 130b may include LEDs that are configured to illuminate based on the sensed position of the second side of the blade 34. Accordingly, various regions of the first and second light sources 130a, 130b are configured to alert the operator of the position of the respective first and second sides of the blade 34 relative to a pre-programmed grade elevation. As noted herein, in other embodiments, the first and second indicators (and therefore the first and second light sources 130a, 130b) may be configured to illuminate based on any one of the plurality of characteristics noted. In other embodiments, the light sources 130a, 130b illuminate light bars or gradients, but in other embodiments the light sources may illuminate any suitable indicators. For example, the light source indicators may be numbers, words, phrases, graphics (e.g., maps, user inputs, arrows, etc.), or any other suitable visual indicator.

Further with respect to FIG. 4, the first projector 96a may include a first light source 140a on the first side 92a of the console 92. The first light source 140a is configured to correspond to the first indicator on the operator interface 58. For example, the first light source 140a may have LEDs (or another suitable light source, such as one or more lasers) that correspond to the LEDs of the first light source 130a. In the illustrated embodiment, each of the LEDs of the first light source 140a is configured to correspond to one of the LEDs of the first light source 130a. Similarly, the second projector 96b may include a second light source 140b on the second side of the console. The second light source 140b is configured to correspond to the second indicator on the operator interface 58. Again, for example, the second light source 140b has LEDs (or another suitable light source such as one or more lasers) that correspond to the LEDs of the second light source 130b. In the illustrated embodiment, each of the LEDs of the second light source 140b is configured to correspond to one of the LEDs of the second light source 130b. In other embodiments, the first and second projectors 96a, 96b may include any suitable configuration that is able to convey information from the operator interface 58.

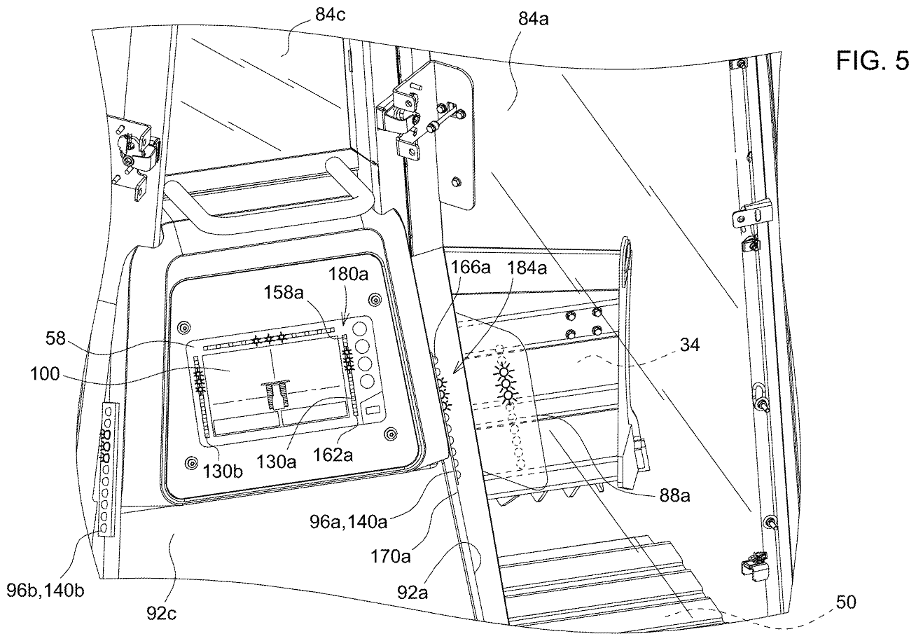

As the operator operates the vehicle, the vehicle controller 110 is configured to detect one or more of the plurality of characteristics (such as the position of the blade 34) corresponding to the operation of the vehicle 10. The vehicle controller 110 is configured to generate one or more signals corresponding to the one or more plurality of indicators and send the one or more signals to the operator interface 58. One or more of the light sources 130a, 130b of the operator interface 58 are configured to illuminate based on the one or more signals received from the vehicle controller 110. Moreover, the micro-controller 104 is configured to illuminate the first and second lights sources 140a, 140b of the projectors 96a, 96b corresponding to the illumination of the one or more lights sources 130a, 130b of the operator interface 58. The light from the illuminated first and second lights sources 140a, 140b is then reflected on the reflective film 88a, 88b of the respective first and second windows 84a, 84b. As shown and described in detail with respect to FIGS. 5-9, the projectors 96a, 96b may project a single one of the plurality of indicators onto the respective windows 84a, 84b. In other embodiments, the projectors 96a, 96b, 96c may project one or more of the indicators onto the respective windows 84a, 84b, 84c. For example, all of the indicators of the entire operator interface 58 may be projected onto the respective windows 84a, 84b, 84c.

With specific reference to FIGS. 5-9, as the first side of the blade 34 moves, the GPS 114 is configured to detect the position of the first side of the blade 34 based on the first sensor 70a to determine a position of the first side of the blade 34 relative to the pre-determined grade elevation. The vehicle controller 110 is configured to receive the blade 34 position information from the GPS 114. The vehicle controller 110 is configured to generate a signal corresponding to the blade 34 information received from the GPS 114 and send the signal to the first light source 130a of the operator interface 58. The first light source 130a of the operator interface 58 is configured to illuminate based on the signal received from the vehicle controller 110. Moreover, the micro-controller 104 is configured to illuminate the first light source 140a of the first projector 96a corresponding to the first light source 130a of the operator interface 58. The light from the illuminated first LED source 140a of the first projector 96a is then projected on the first window 84a and reflected by the reflective film 88a. Although not specifically illustrated in FIGS. 5-9 or discussed relative thereto, it should be understood that the second side of the blade 34, the second light source 130b, and the second light source 140b operate in the same way that the first side of the blade 34, the first light source 130a, and the first light source 140a.

With specific reference to FIG. 5, when the GPS 114 detects, via the first sensor 70a, that the first side of the blade 34 is at the desired pre-programmed elevation, the vehicle controller 110 is configured to receive the blade 34 information from GPS 114 and to illuminate a first region 150a of the first light source 130a of the operator interface 58 based on a first signal. Also, the micro-controller 104 is configured to illuminate a first region 154a of the first light source 140a of the first projector 96a corresponding to the first region 150a of the first light source 130a of the operator interface 58. The light of the illuminated first region of the first light source 140a is then projected on the first window 84a and reflected by the reflective film 88a. In the illustrated embodiment, the first region 150a of the first light source 130a of the operator interface 58 is positioned between its first end 158a and its second end 162a, and similarly, the first region 154a of the first light source 140a of the first projector 96a is positioned between its first end 166a and its second end 170a.

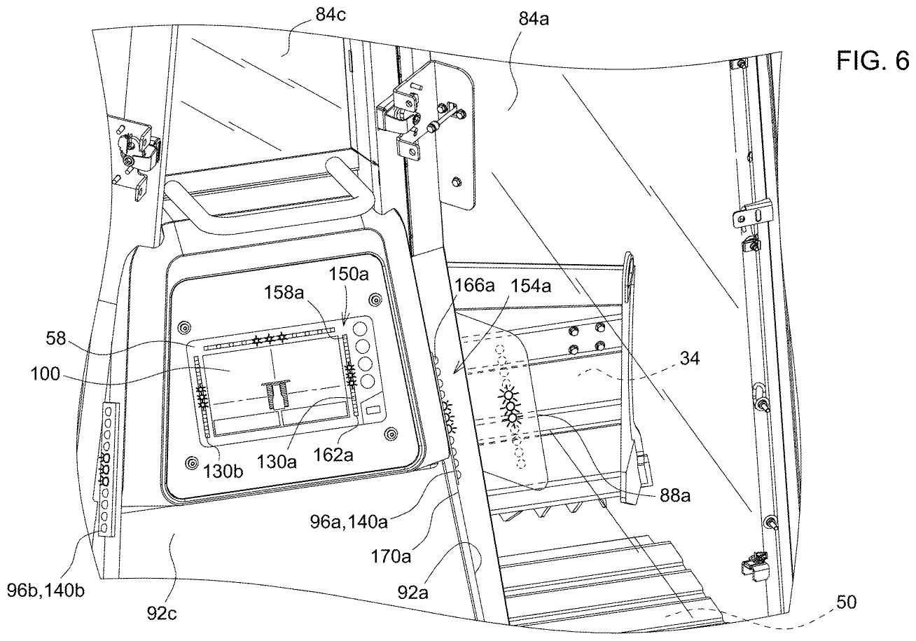

With respect to FIG. 6, when the GPS 114 detects, via the first sensor 70a, that the first side of the blade 34 is above the desired pre-programmed elevation by a first amount, the vehicle controller 110 is configured to receive the blade 34 information from GPS 114 and to illuminate a second region 180a of the first light source 130a of the operator interface 58 based on a second signal. Also, the micro-controller 104 is configured to illuminate a second region 184a of the first light source 140a of the first projector 96a corresponding to the second region 180a of the first light source 130a of the operator interface 58. The light of the illuminated second region 180a of the first light source 140a is then projected on the first window 84a and reflected by the reflective film 88a. In the illustrated embodiment, the second region 180a of the first light source 130a of the operator interface 58 is positioned between its first region 150a and its first end 158a, and similarly, the second region 184a of the first light source 140a of the first projector 96a is positioned between its first region 154a and its first end 166a.

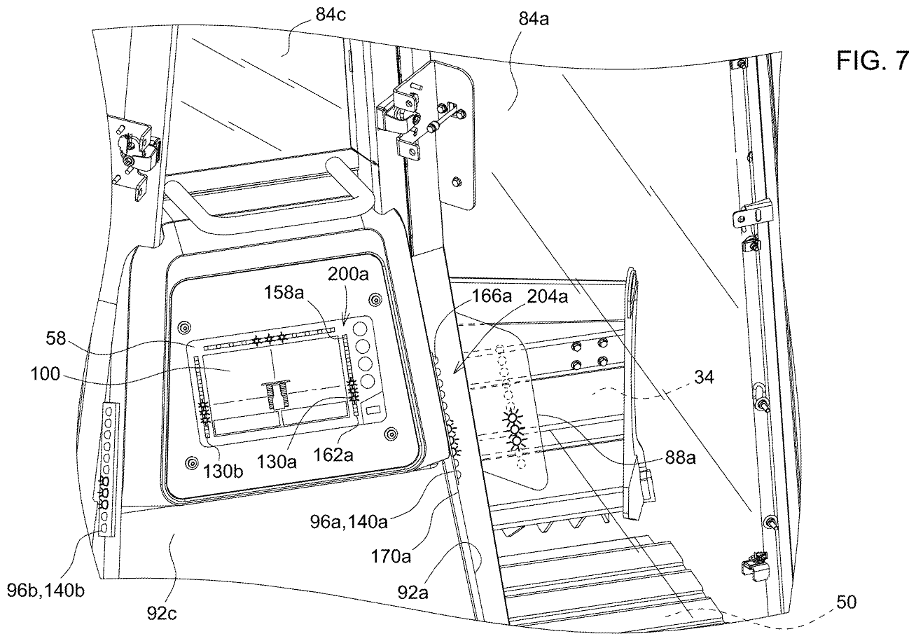

With respect to FIG. 7, when the GPS 114 detects, via the first sensor 70a, that the first side of the blade 34 is above the desired pre-programmed elevation by a second amount that is greater than the first amount, the vehicle controller 110 is configured to receive the blade 34 information from GPS 114 and to illuminate a third region 190a of the first light source 130a of the operator interface 58 based on a third signal. Also, the micro-controller 104 is configured to illuminate a third region 194a of the first light source 140a of the first projector 96a corresponding to the third region 190a of the first light source 130a of the operator interface 58. The light of the illuminated third region of the first light source 140a is then projected on the first window 84a and reflected by the reflective film 88a. In the illustrated embodiment, the third region 190a of the first light source 130a of the operator interface 58 is positioned at its first end 158a, and similarly, the third region 194a of the first light source 140a of the first projector 96a is positioned at its first end 166a.

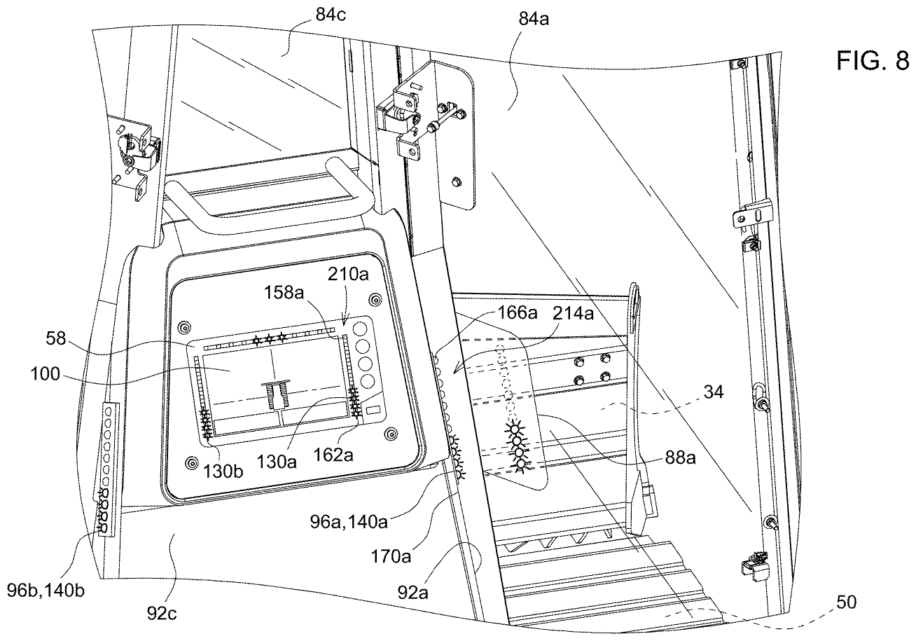

With respect to FIG. 8, when the GPS 114 detects, via the first sensor 70a, that the first side of the blade 34 is below the desired pre-programmed elevation by a first amount, the vehicle controller 110 is configured to receive the blade 34 information from GPS 114 and to illuminate a fourth region 200a of the first light source 130a of the operator interface 58 based on a fourth signal. Also, the micro-controller 104 is configured to illuminate a fourth region 204a of the first light source 140a of the first projector 96a corresponding to the fourth region 200a of the first light source 130a of the operator interface 58. The light of the fourth region of the first light source 140a is then projected on the first window 84a and reflected by the reflective film 88a. In the illustrated embodiment, the fourth region 200a of the first light source 130a of the operator interface 58 is positioned between its first region 154a and its second end 162a, and similarly, the fourth region 134a of the first light source 140a of the first projector 96a is positioned between its first region 154a and its second end 170a.

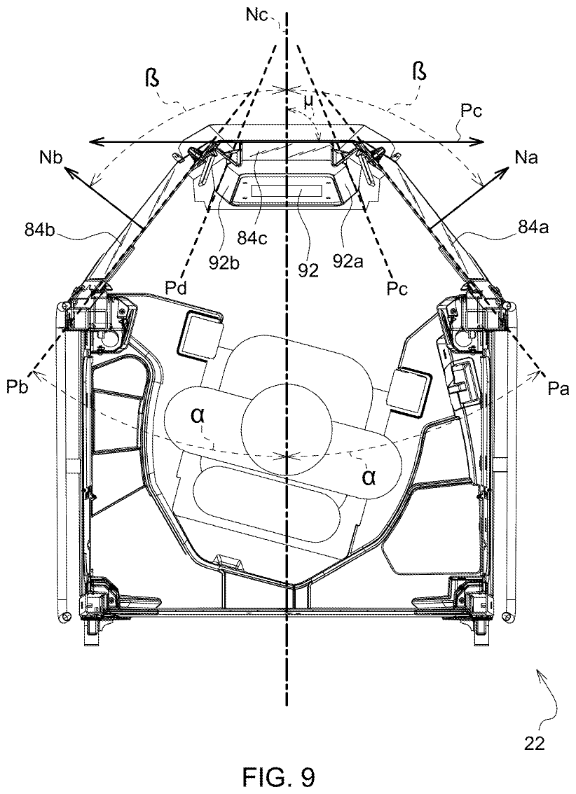

With respect to FIG. 9, when the GPS 114 detects, via the first sensor 70a, that the first side of the blade 34 is below the desired pre-programmed elevation by a second amount that is greater than the first amount, the vehicle controller 110 is configured to receive the blade 34 information from GPS 114 and to illuminate a fifth region 210a of the first light source 130a of the operator interface 58 based on a fifth signal. Also, the micro-controller 104 is configured to illuminate a fifth region 214a of the first light source 140a of the first projector 58 corresponding to the fifth region 210a of the first light source 130a of the operator interface 58. The light of the fifth region of the first light source 140a is then projected on the window 84a and reflected by the reflective film 88a. In the illustrated embodiment, the fifth region 210a of the first light source 130a of the operator interface 58 is positioned at its second end 166a, and similarly, the fifth region 214a of the first light source 140a of the first projector 96a is positioned at its second end 170a.

In the illustrated embodiment, each of the regions of both the first light source 130a and the first light source 140a includes three LEDs, but in other embodiments, each of the regions may include more or fewer LEDs. Additionally, the regions of the LEDs of both the first light source 130a and the first light source 140a may overlap. That is, one or more of the LEDs of one of the regions may also be included as one or more LEDs of either or both of the adjacent regions. Accordingly, although the first light source 130a and the first light source 140a are only described as each having five regions, the first light source 130a and the first light source 140a may have any suitable number of regions that convey to the operator the position of the first side of the blade 34 relative to the desired pre-programmed elevation. The plurality of LEDs in each of the regions of both the first light source 130a and the first light source 140a may have the same color or different colors. The plurality of LEDs may create a gradient within each region and/or along the entire light source 130a, 130b and light source 140a, 140b. Additionally, in other embodiments, the light sources 130a, 130b, 140a, 140b may include lasers rather than LEDs.

Although the first and second projectors 96a, 96b are shown and described in the illustrated embodiment of FIGS. 5-9 as including a light sources 140a, 140b that corresponds to the respective light sources 130a, 130b, it should be understood that in other embodiments, the first and second projectors 96a, 96b may be configured to display additional or other information from the display screen 100 of the operator interface. In other words, each of the projectors 96a, 96b, 96c may display other or additional information on the windows 84a, 84b, 84c, as shown in FIG. 10.

Although the present subject matter has been described in detail with reference to certain embodiments, variations and modifications exist within the scope of one or more independent claims of the present subject matter, as described.

1. A work vehicle comprising:
a chassis having a first side and a second side opposite the first side;
a prime mover supported by the chassis and configured to move the work vehicle relative to a support surface;
an operator cab supported by the chassis, the operator cab including a plurality of windows and an operator interface, a first of the plurality of windows being positioned on the first side of the chassis and a second of the plurality of windows being positioned on the second side of the chassis;
a work attachment movably coupled to the chassis, the work attachment being visible from the operator cab through at least one of the first window or the second window;
a control system configured to determine an operational characteristic of the work attachment relative to the support surface and display the operational characteristic via the operator interface; and
a projector in communication with the operator interface and positioned adjacent to the one of the first window or the second window, the projector configured to project information from the operator interface onto the one of the first window or the second window at a location through which, during operation of the work vehicle, at least a portion of the work attachment at or adjacent the support surface is visible by an operator positioned in the operator cab.

2. The work vehicle of claim 1, further comprising a reflective film positioned on at least a portion of the one of the first window and the second window, the projector configured to project the information from the operator interface onto the reflective film.

3. The work vehicle of claim 1, wherein the operator cab further includes a console including a first side that supports the operator interface and a second side that supports the projectors, the second side being positioned adjacent to the one of the first window and the second window.

4. The work vehicle of claim 1, wherein the operator interface includes a first indicator that corresponds to the operational characteristic of the work attachment and the projector includes a first light source corresponding to the first indicator, the control system being configured to illuminate the first indicator onto the one of the first window or the second window via the first light source.

5. The work vehicle of claim 1, wherein the one of the first window and second window is positioned at an acute angle relative to a longitudinal axis of the chassis.

6. The work vehicle of claim 5, wherein the angle is about 30 degrees to about 60 degrees.

7. (canceled)

8. A work vehicle comprising:
a chassis having a longitudinal axis;
a prime mover supported by the chassis; and
an operator cab supported by the chassis, the operator cab including:
a window having an external surface that defines a vector normal thereto, the vector being parallel to a support surface and positioned at an acute angle relative to the longitudinal axis;
an operator interface including a display screen configured to display information about the operation of the work vehicle to the operator, and
a projector adjacent to the window and in communication with the operator interface and configured to project the information displayed by the operator interface onto the window.

9. The work vehicle of claim 8, wherein the angle is about 30 degrees to about 60 degrees.

10. The work vehicle of claim 8, wherein the operator cab further includes a console including a first side, a second side, and a third side positioned between the first side and the second side, at least one of the first side and the second side positioned adjacent to the window and supporting the projector, the operator interface supported by the third side.

11. The work vehicle of claim 8, wherein the projector is configured to project the information on the window at or adjacent to a location through which, during operation of the work vehicle, at least a portion of the work attachment is visible by an operator positioned in the operator cab.

12. The work vehicle of claim 8, further comprising a reflective film positioned on at least a portion of the window, the projector configured to project the information from the operator interface onto the reflective film.

13. The work vehicle of claim 8, further comprising a micro-controller in communication with the operator interface and the projector, the micro-controller configured to communicate the information displayed on the operator interface to the projector.

14. The work vehicle of claim 8, further comprising a control system including a controller in communication with the operator interface, the controller configured to send the information about operation of the work vehicle to the operator interface.

15. The work vehicle of claim 8, further comprising
a work attachment movably coupled to the chassis, at least a portion of the work attachment visible through the window, and
a control system in communication with the operator interface, the control system configured to determine a position of the work attachment relative to a support surface, send a position signal to the operator interface and to the projector, and display the position on the operator interface.

16. The work vehicle of claim 8, wherein the operator interface includes an indicator and the projector includes a light source, the control system being configured to illuminate the indicator onto the window via the light source.

17. A work vehicle comprising:
a chassis;
a prime mover supported by the chassis;
an operator cab supported by the chassis and including at least one window;
an operator interface positioned in an operator cab and configured to display information about operation of the work vehicle; and
a projector configured to project the information from the operator interface onto one of the at least one window such that information displayed on the operator interface is concurrently visible on the at least one window.

18. The work vehicle of claim 17, further comprising a control system including a controller in communication with the operator interface, the controller configured to send the information about operation of the work vehicle to the operator interface and the projector.

19. The work vehicle of claim 18, wherein the projector includes a light source, the control system being configured to illuminate at least one of a plurality of indicators displayed by the operator interface onto the window via the light source.

20. The work vehicle of claim 17, further comprising
a work attachment movably coupled to the chassis, at least a portion of the work attachment visible through the window, and
a control system in communication with the operator interface, the control system configured to determine a position of the work attachment relative to a support surface, send a position signal to the operator interface and to the projector, and display the position on the operator interface.
